(19) United States
(12) Patent Application Publication
(10) Pub. No.: US 2017/0148404 A1
(43) Pub. Date: May 25, 2017

(54) LIQUID CRYSTAL DISPLAY PANEL, DISPLAY DEVICE, AND DRIVING METHOD

(71) Applicant: Wuhan China Star Optoelectronics Technology Co., Ltd., Wuhan, Hubei (CN)

(72) Inventors: Zhenzhou Xing, Wuhuan, Hubei (CN); Qingcheng Zuo, Wuhuan, Hubei (CN); Chun Hung Huang, Wuhan, Hubei (CN)

(73) Assignee: Wuhan China Star Optoelectronics Technology Co., Ltd., Wuhan, Hubei (CN)

(21) Appl. No.: 14/786,023

(22) PCT Filed: Jun. 18, 2015
(86) PCT No.: PCT/CN2015/081760

§ 371 Date: Dec. 31, 2015

(30) Foreign Application Priority Data
May 26, 2015 (CN) 201510274900.X

(51) Int. Cl. G09G 3/36; G02F 1/1362; G02F 1/1368

(52) U.S. Cl. CPC G09G 3/3677; G02F 1/1368; G02F 1/136286; G09G 3/3688; G02F 2201/123; G09G 2300/0809; G09G 2310/0251

(57) ABSTRACT

A liquid crystal display panel, a display device, and a driving method thereof are disclosed. The liquid crystal display panel comprises a plurality of data line pairs, a plurality of scanning lines, and a pixel unit array, wherein the first scanning line and the second scanning line turn on TFT switches of two rows of pixel units simultaneously according to a scanning driving signal, and the first data line and the second data line charge the pixel electrodes of two rows of pixel units through the TFT switches according to a data driving signal.

### CROSS REFERENCE TO RELATED APPLICATION

The present application claims benefit of Chinese patent application CN 201510274900.X, entitled “Liquid Crystal Display Panel, Display Device, and Driving Method” and filed on May 26, 2015, the entirety of which is incorporated herein by reference.

### FIELD OF THE INVENTION

The present disclosure relates to the technical field of liquid crystal display, and particularly to a liquid crystal display panel, a display device, and a driving method thereof

### BACKGROUND OF THE INVENTION

In a liquid crystal display device in the prior art, images are generally displayed in a line-by-line scanning driving method. As shown in FIG. 1, the liquid crystal display panel comprises a plurality of pixel units that are defined by a plurality of scanning lines (G1 to Gn) and a plurality of data lines (D1 to Dm) crossing over with one another, and each pixel unit comprises a pixel electrode. When the line-by-line scanning is performed, a scanning signal is first provided to the first scanning line G1, and the pixel electrode in the first row is charged by the data line. Then, the scanning signal is provided to the second scanning line G2, and the pixel electrode in the second row is charged by the data line. The pixel electrodes in other rows are charged in the similar manner.

Under the display panel structure and the driving method, the refresh rate of the display panel increases with the increasing of the resolution and definition of the panel. As a result, the charge time of the pixel electrode is insufficient, and thus the display quality of the image would be suffered.

Therefore, a liquid crystal display panel, a display device, and a driving method by which the charge time of the pixel electrode can be increased are urgently needed.

### SUMMARY OF THE INVENTION

The present disclosure aims to solve the technical problem of insufficient charge of the pixel electrode when the resolution of the screen increases in the prior art.

The present disclosure first provides a liquid crystal display panel, comprising: a plurality of data line pairs, each data line pair comprising a first data line and a second data line that are arranged side by side; a plurality of scanning lines, comprising a first scanning line and a second scanning line that are arranged alternately and perpendicular to the plurality of data line pairs; and a pixel unit array, comprising a plurality of pixel units, each of which is arranged in a respective one of areas formed by the plurality of data line pairs and the plurality of scanning lines crossing over with one another respectively, each pixel unit comprising a pixel electrode and a Thin Film Transistor (TFT) switch, wherein the first scanning line and the second scanning line turn on TFT switches of two rows of pixel units simultaneously according to a scanning driving signal, and the first data line and the second data line charge the pixel electrodes of two rows of pixel units through the TFT switches according to a data driving signal.

According to one embodiment, each column of pixel units are arranged on a same side of a corresponding data line pair, and sources of the TFT switches of each column of pixel units are connected with the first data line and the second data line of said corresponding data line pair alternately.

According to one embodiment, the first scanning line and the second scanning line are arranged adjacent to each other and separated by one row of pixel units, and a first pixel unit and a second pixel unit of each column of pixel units are arranged alternately.

According to one embodiment, the first scanning line and the second scanning line are separated by k rows of pixel units, k first scanning lines are arranged adjacent to each other, and k second scanning lines are arranged adjacent to each other, k being equal to or larger than 2 and equal to or less than n/2, n being a number of rows of the pixel unit array, k and n being positive integers; and each column of pixel units comprises a first pixel unit group and a second pixel unit group that are arranged alternately, the first pixel unit group comprising k adjacent first pixel units, and the second pixel unit group comprising k adjacent second pixel units.

According to one embodiment, a gate of the TFT switch of the first pixel unit is connected with the first scanning line, and a source thereof is connected with the first data line; and a gate of the TFT switch of the second pixel unit is connected with the second scanning line, and a source thereof is connected with the second data line.

According to a second aspect, the present disclosure further provides a liquid crystal display device, comprising: the aforesaid liquid crystal display panel; a scanning driving unit, used for providing a scanning driving signal to the first scanning line and the second scanning line, so as to turn on TFT switches of two rows of pixel units simultaneously; and a data driving unit, used for providing a data driving signal to the first data line and the second data line, so as to charge the pixel electrodes of two rows of pixel units through the TFT switches.

According to one embodiment, the data driving unit further charges the pixel electrodes of each column of pixel units through the first data line and the second data line alternately.

According to a third aspect, the present disclosure further provides a method for driving a liquid crystal display device, comprising the following steps: providing a scanning driving signal to a first scanning line and a second scanning line, and turning on TFT switches of two rows of pixel units simultaneously; and providing a data driving signal to a first data line and a second data line, and charging pixel electrodes of two rows of pixel units through the TFT switches.

According to one embodiment, the method further comprises charging the pixel electrodes of each column of pixel units through the first data line and the second data line alternately.

According to one embodiment, under the condition that the first scanning line and the second scanning line are arranged adjacent to each other and separated by one row of pixel units, the method comprises charging pixel electrodes of a first pixel unit and a second pixel unit of each column of pixel units through the first data line and the second data line alternately; and under the condition that the first scanning line and the second scanning line are separated by k rows of pixel units, k first scanning lines are arranged adjacent to each other, and k second scanning lines are arranged adjacent to each other, the method comprises charging pixel electrodes of a first pixel unit group and a second pixel unit group of each column of pixel units through the first data line and the second data line alternately, the first pixel unit group comprising k adjacent first pixel units, the second pixel unit group comprising k adjacent second pixel units, k being equal to or larger than 2 and equal to or less than n/2, n being a number of rows of the pixel unit array, k and n being positive integers.

According to the embodiments of the present disclosure, the scanning signal can be provided to the first scanning line and the second scanning line simultaneously during one time-sequence, and the data can also be transmitted to the first data line and the second data line simultaneously during said time-sequence, so that the pixel electrodes of two rows of pixel units can be charged at the same time. In this case, the charge time of the pixel electrodes can be doubled. The display effect is more stable since the charge time of the pixel electrodes is prolonged. The advantage of the present disclosure is more significant when it is used in the display device of high resolution.

Other features and advantages of the present disclosure will be further explained in the following description, and partially become self-evident therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE DRAWINGS

The accompanying drawings provide further understandings of the present disclosure and constitute one part of the description. The drawings are used for interpreting the present disclosure together with the embodiments, not for limiting the present disclosure. In the drawings:

FIG. 1 schematically shows a structure of a liquid crystal display panel in the prior art;

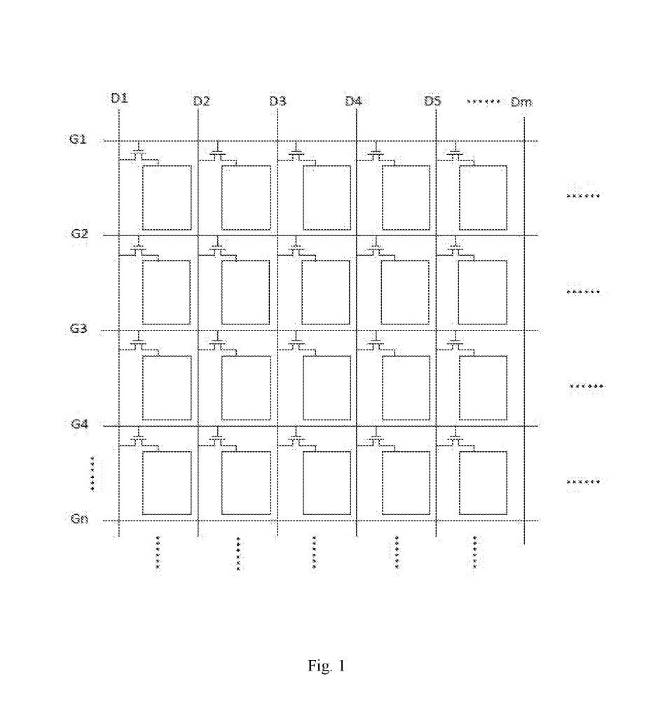

FIG. 2 schematically shows a structure of a liquid crystal display device according to embodiment 1 of the present disclosure;

FIG. 3 schematically shows a structure of a liquid crystal display panel according to embodiment 1 of the present disclosure;

FIG. 4 is a signal time-sequence diagram of the liquid crystal display device according to embodiment 1 of the present disclosure;

FIG. 5 is a flow chart of a method for driving the liquid crystal display device according to embodiment 1 of the present disclosure;

FIG. 6 schematically shows a structure of a liquid crystal display panel according to embodiment 2 of the present disclosure;

FIG. 7 is a signal time-sequence diagram of the liquid crystal display device according to embodiment 2 of the present disclosure;

FIG. 8 schematically shows a structure of a liquid crystal display panel according to embodiment 3 of the present disclosure;

FIG. 9 is a signal time-sequence diagram of the liquid crystal display device according to embodiment 3 of the present disclosure;

FIG. 10 schematically shows a structure of a liquid crystal display panel according to embodiment 4 of the present disclosure; and

FIG. 11 is a signal time-sequence diagram of the liquid crystal display device according to embodiment 4 of the present disclosure.

### DETAILED DESCRIPTION OF THE EMBODIMENTS

The present disclosure will be illustrated in detail hereinafter in combination with the accompanying drawings to make the purpose, technical solutions, and advantages of the present disclosure more clear.

### Embodiment 1

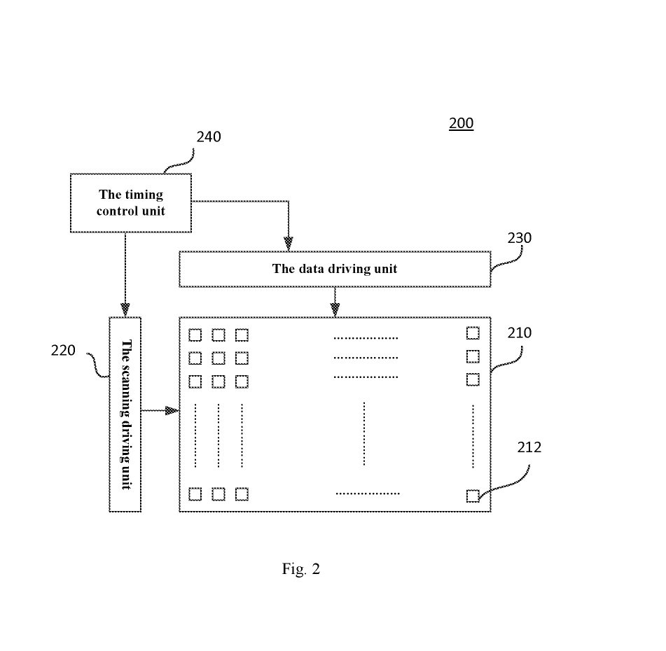

FIG. 2 schematically shows a structure of a liquid crystal display device 200 according to the present embodiment. As shown in FIG. 2, the liquid crystal display device 200 comprises a display panel 210, a scanning driving unit 220, a data driving unit 230, and a timing control unit 240. The display panel 210 comprises a plurality of pixel units 212 that are arranged in an array.

The scanning driving unit 220 and the data driving unit 230 are electrically connected with the display panel 210 respectively. The timing control unit 240 is electrically connected with the scanning driving unit 220 and the data driving unit 230, so that the display panel 210 can be scanned by the scanning driving unit 220 and be driven by the data driving unit 230 under the control of the timing control unit 240 and the image can be displayed.

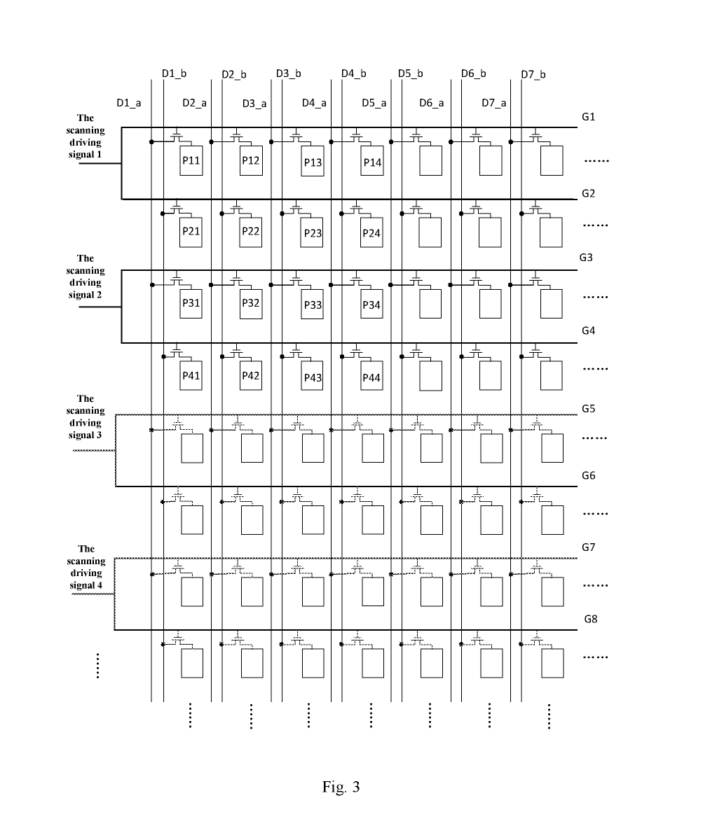

FIG. 3 schematically shows a structure of a display panel 210 according to the present embodiment. According to the present embodiment, the display panel 210 comprises a plurality of data line pairs, a plurality of scanning lines, and a pixel unit array.

Each data line pair comprises a first data line and a second data line that are arranged side by side. As shown in FIG. 3, a data line D1_a and a data line D1_b constitute a data line pair, and similarly, a data line D7_a and a data line D7_b constitute a data line pair, wherein D1_a, D2_a, . . . , and D7_a are the first data lines, and D1_b, D2_b, . . . , and D7_b are the second data lines.

There are a plurality of scanning lines (G1 to G8) in FIG. 3. Specifically, the plurality of scanning lines comprise first scanning lines and second scanning lines that are arranged alternately and perpendicular to the plurality of data line pairs. As shown in FIG. 3, G1, G3, G5, etc are the first scanning lines, and G2, G4, G6, etc are the second scanning lines. The first scanning line and the second scanning line are separated by one row of pixel units, and the first scanning line and the second scanning line are arranged adjacent to each other.

The pixel unit array comprises a plurality of pixel units. For the purpose of convenience, only pixel units P11, P12, . . . , P43, and P44 are identified in FIG. 3. The pixel units are arranged in areas defined by the plurality of data line pairs and the plurality of scanning lines crossing over with one another respectively, and each pixel unit comprises a pixel electrode and a TFT switch.

In the display panel 210, each column of pixel units are arranged on a same side of each data line pair, and sources of the TFT switches of each column of pixel units are connected with the first data line and the second data line of the data line pair alternately.

In order to facilitate the illustration, according to the present embodiment, the pixel unit with a gate of the TFT switch being connected with the first scanning line and a source thereof being connected with the first data line is defined as “the first pixel unit”, and the pixel unit with a gate of the TFT switch being connected with the second scanning line and a source thereof being connected with the second data line is defined as “the second pixel unit”. Then, in FIG. 3, the first pixel units and the second pixel units in each column are arranged alternately. Taking the pixel units in the first column as an example, the source of the TFT switch of the first pixel unit P11 is connected with the first data line D1_a, and the gate thereof is connected with the first scanning line G1; and the source of the TFT switch of the second pixel unit P21 is connected with the second data line D1_b, and the gate thereof is connected with the second scanning line G2. Similarly, the source of the TFT switch of the first pixel unit P31 is connected with the first data line D1_a, and the gate thereof is connected with the first scanning line G3; and the source of the TFT switch of the second pixel unit P41 is connected with the second data line D1_b, and the gate thereof is connected with the second scanning line G4.

During the display, the scanning driving signal is provided to the first scanning line and the second scanning line by the scanning driving unit, so that the TFT switches of two rows of pixel units can be turned on simultaneously. The data driving signal is provided to the first data line and the second data line by the data driving unit, so that the pixel electrodes of two rows of pixel units can be charged through the TFT switches.

Specifically, the scanning line G1 and the scanning line G2 are connected with the TFT switches of the first row of pixel units and the TFT switches of the second row of pixel units respectively, so that the TFT switches of the first row of pixel units and the TFT switches of the second row of pixel units can be turned on simultaneously according to the scanning driving signal 1 during the display, and the pixel electrodes of the pixel units in the first row and the second row can be charged by the data lines D1_a, D1_b, D2_a, D2_b, etc through the TFT switches according to the data driving signal. Similarly, the TFT switches of the third row of pixel units and the TFT switches of the fourth row of pixel units can be turned on simultaneously by the scanning lines G3 and G4 according to the scanning driving signal 2, and the pixel electrodes of the pixel units in the third row and the fourth row can be charged by the data lines through the TFT switches. In this manner, the turned-on time of the TFT switches of the first row of pixel units, the second row of pixel units, the third row of pixel units, and the fourth row of pixel units all can be doubled. Therefore, the turned-on time of the TFT switches in each row of pixel units can be increased, and thus the charge time of the pixel electrodes can be prolonged.

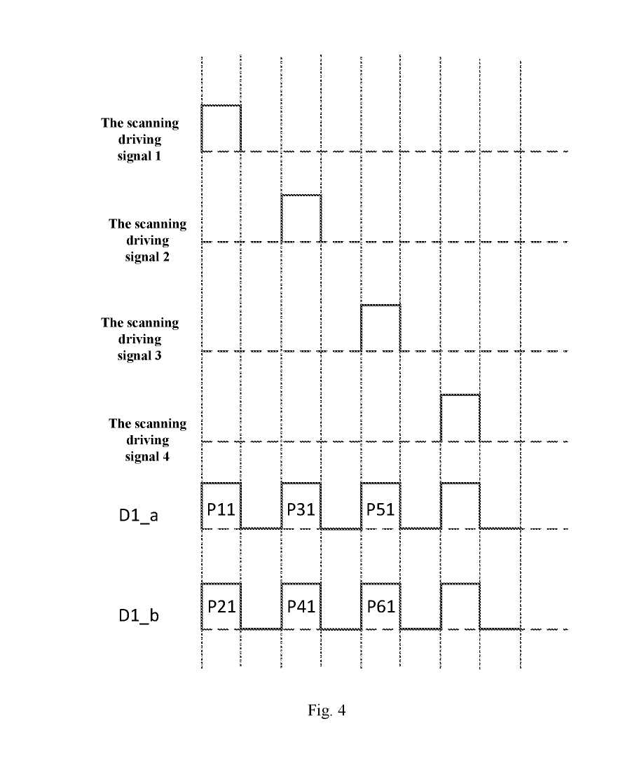

As aforementioned, the first pixel units and the second pixel units in each column are arranged alternately, and thus the pixel electrodes of each column of pixel units are charged by the data driving unit through the first data line and the second data line alternately. As shown in FIG. 4, taking the pixel units in the first column as an example, the pixel electrodes of the pixel units P11 and P31 are charged by the first data line D1_a, and the pixel electrodes of the pixel units P21 and P41 are charged by the second data line D1_b.

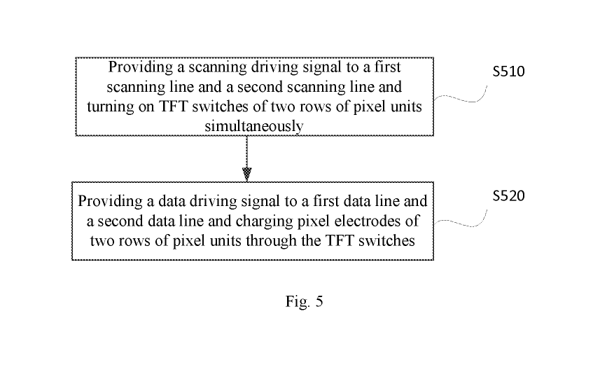

The present embodiment further provides a method for driving the liquid crystal display device 200. As shown in FIG. 5, the method comprises the following steps. First, in step S510, a scanning driving signal is provided to a first scanning line and a second scanning line, and TFT switches of two rows of pixel units are turned on simultaneously. Then, in step S520, a data driving signal is provided to a first data line and a second data line, and pixel electrodes of two rows of pixel units are charged through the TFT switches. Specifically, the pixel electrodes of each column of pixel units can be charged through the first data line and the second data line alternately. In the display panel as shown in FIG. 3, the first scanning line and the second scanning line are separated by one row of pixel units, the first scanning line and the second scanning line are arranged adjacent to each other, and the pixel electrodes of the first pixel units and the second pixel units of each column of pixel units are charged through the first data line and the second data line alternately. The pixel units, the scanning lines, and the data lines are all arranged in the mode as aforementioned, and the details of which are no longer repeated here.

### Embodiment 2

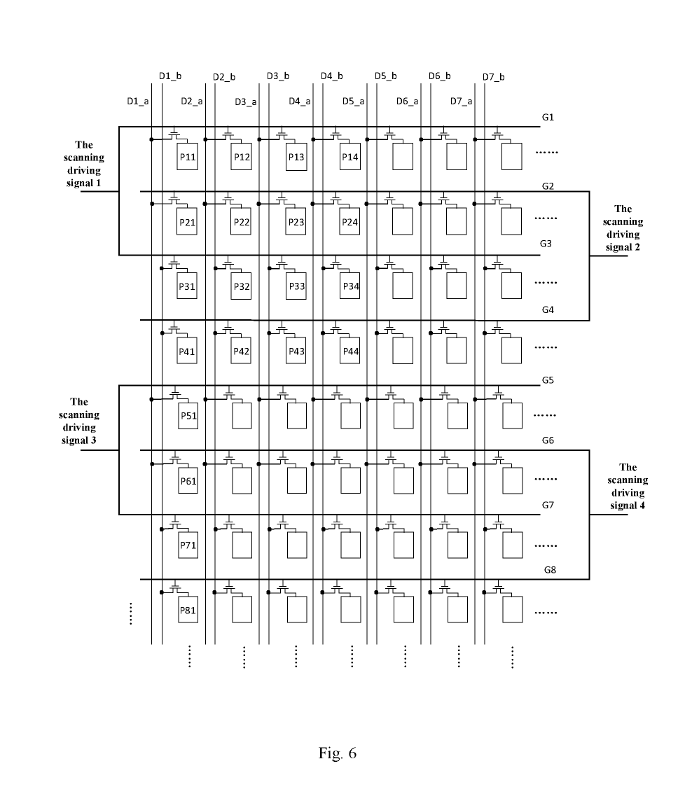

FIG. 6 schematically shows a structure of a liquid crystal display panel according to the present embodiment. The data lines are arranged in the same manner as embodiment 1, and the details of which are no longer repeated here. However, the scanning lines are arranged in a manner different from that of embodiment 1. As shown in FIG. 6, G1, G2, G5, and G6 are the first scanning lines, and G3, G4, G7, and G8 are the second scanning lines. The first scanning line G1 and the second scanning line G3 are separated by two rows of pixel units, and the first scanning line G2 and the second scanning line G4 are also separated by two rows of pixel units. The first scanning line G1 and the first scanning line G2 are arranged adjacent to each other, and the second scanning line G3 and the second scanning line G4 are arranged adjacent to each other.

In order to facilitate the illustration, according to the present embodiment, two consecutive first pixel units in each column is defined as “the first pixel unit group”, and similarly, two consecutive second pixel units in each column is defined as “the second pixel unit group”. Taking the pixel units in the first column as an example, the pixel units P11 and P21 constitute the first pixel unit group, the pixel units P51 and P61 constitute the first pixel unit group, the pixel units P31 and P41 constitute the second pixel unit group, and the pixel units P71 and P81 constitute the second pixel unit group. Then, in the first column, the first pixel unit groups and the second pixel unit groups are arranged alternately, and the sources of the TFT switches of the pixel units of the first pixel unit groups and the second pixel unit groups are connected with the first data line and the second data line alternately.

The structure of the liquid crystal display device according to the present embodiment is the same as that of embodiment 1. However, since the structure of the scanning lines of the liquid crystal display panel according to the present embodiment is different from that of embodiment 1, the method for driving the liquid crystal display device according to the present embodiment is different from that of embodiment 1.

During the display, the scanning driving signal is provided to the first scanning line and the second scanning line by the scanning driving unit, so that the TFT switches of two rows of pixel units can be turned on simultaneously. The data driving signal is provided to the first data line and the second data line by the data driving unit, so that the pixel electrodes of two rows of pixel units can be charged through the TFT switches.

As shown in FIG. 6, the scanning line G1 and the scanning line G3 are connected with the TFT switches of the pixel units in the first row and the third row respectively. During display, the TFT switches of the pixel units in the first row and the third row can be turned on simultaneously according to the scanning driving signal 1, and the pixel electrodes of the pixel units in the first row and the third row can be charged by the data lines D1_a, D1_b, D2_a, D2_b, etc through the TFT switches according to the data driving signal. Similarly, the TFT switches of the pixel units in the second row and the fourth row can be turned on simultaneously by the scanning lines G2 and G4 according to the scanning driving signal 2, and the pixel electrodes of the pixel units in the second row and the fourth row can be charged by the data lines through the TFT switches. In this manner, the turned-on time of the TFT switches of the first row of pixel units, the third row of pixel units, the second row of pixel units, and the fourth row of pixel units all can be doubled. Therefore, the turned-on time of the TFT switches can be increased, and thus the charge time of the pixel electrodes can be prolonged.

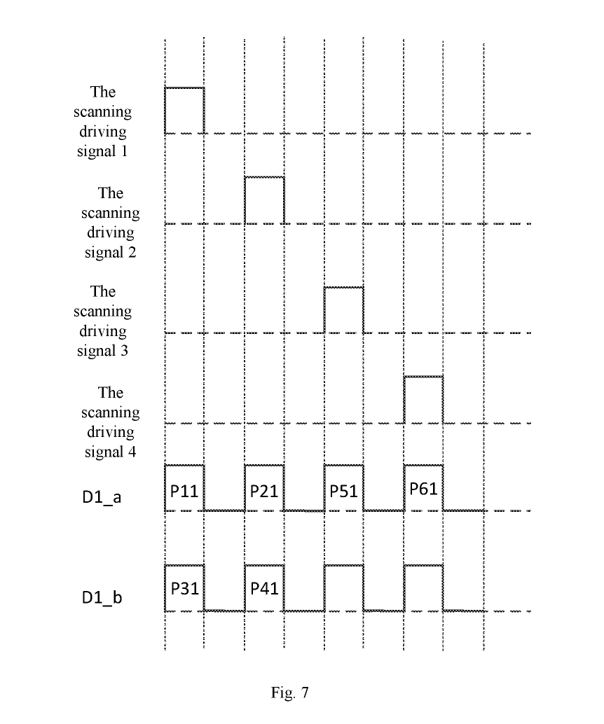

As aforementioned, the first pixel unit groups and the second pixel unit groups in each column are arranged alternately, and thus the pixel electrodes of the first pixel unit groups and the second pixel unit groups of each column of pixel units are charged through the first data line and the second data line alternately. As shown in FIG. 7, taking the pixel units in the first column as an example, the pixel electrodes of the pixel units P11, P21, P51, and P61 are charged by the first data line D1_a, and the pixel electrodes of the pixel units P31 and P41 are charged by the second data line D1_b. The pixel units P11 and P21 constitute the first pixel unit group, the pixel units P31 and P41 constitute the second pixel unit group, and the pixel units P51 and P61 constitute the first pixel unit group.

It can be understood that, the first scanning line and the second scanning line can be arranged to be separated by three rows of pixel units or four rows of pixel units. If the first scanning line and the second scanning line are separated by k rows of pixel units, the condition that k is equal to or larger than 2 and equal to or less than n/2 shall be satisfied, wherein n is the number of rows of the pixel unit array, and k as well as n are positive integers.

### Embodiment 3

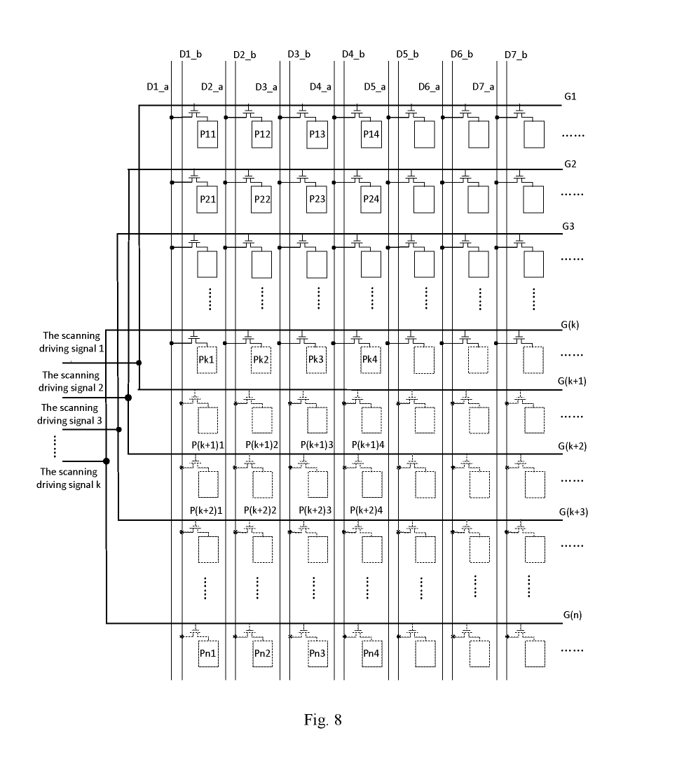

The present embodiment provides a technical solution that the first scanning line and the second scanning line are separated by k rows of pixel units. FIG. 8 schematically shows a structure of a liquid crystal display panel according to the present embodiment. G1, G2, . . . , and G(k) are the first scanning lines, and G(k+1), G(k+2), . . . , and G(n) are the second scanning lines. In order to facilitate the understanding, according to the present embodiment, n is preferably selected to be an even number, and k=n/2. As shown in FIG. 8, the first scanning line G1 and the second scanning line G(k+1) are separated by k rows of pixel units, k first scanning lines are arranged adjacent to each other, and k second scanning lines are arranged adjacent to each other.

Taking the pixel units in the first column as an example, the pixel units P11, P21, . . . , and Pk1 constitute the first pixel unit group, and the pixel units P(k+1)1, . . . , and Pn1 constitute the second pixel unit group. Then, in the first column, the first pixel unit group and the second pixel unit group are arranged alternately, and the sources of the TFT switches of the pixel units of the first pixel unit group and the second pixel unit group are connected with the first data line and the second data line alternately.

The structure of the liquid crystal display device according to the present embodiment is the same as that of embodiment 1. However, since the structure of the scanning lines of the liquid crystal display panel according to the present embodiment is different from that of embodiment 1, the method for driving the liquid crystal display device according to the present embodiment is different from that of embodiment 1.

As shown in FIG. 8, the scanning line G1 and the scanning line G(k+1) are connected with the TFT switches of the first row of pixel units and the TFT switches of the (k+1) row of pixel units respectively, so that the TFT switches of the first row of pixel units and the TFT switches of the (k+1) row of pixel units can be turned on simultaneously according to the scanning driving signal 1 during the display, and the pixel electrodes of the pixel units in the first row and the (k+1) row can be charged by the data lines D1_a, D1_b, D2_a, D2_b, etc through the TFT switches according to the data driving signal. Similarly, the TFT switches of the second row of pixel units and the TFT switches of the (k+2) row of pixel units can be turned on simultaneously by the scanning lines G2 and G(k+2) according to the scanning driving signal 2, and the pixel electrodes of the pixel units in the second row and the (k+2) row can be charged by the data lines through the TFT switches. In this manner, the turned-on time of the TFT switches of the first row of pixel units, the (k+1) row of pixel units, the second row of pixel units, and the (k+2) row of pixel units all can be doubled. Therefore, the turned-on time of the TFT switches in each row of pixel units can be increased, and thus the charge time of the pixel electrodes can be prolonged.

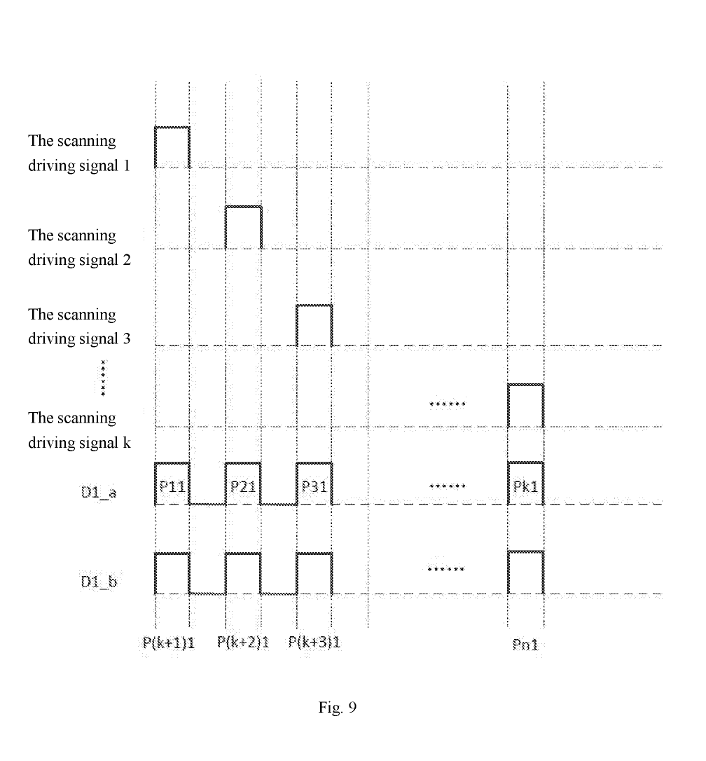

As aforementioned, the first pixel unit group and the second pixel unit group in each column are arranged alternately, and thus the pixel electrodes of the first pixel unit group and the second pixel unit group of each column of pixel units are charged through the first data line and the second data line alternately. As shown in FIG. 9, taking the pixel units in the first column as an example, the pixel electrodes of the pixel units P11, P21, . . . , and Pk1 are charged by the first data line D1 a in sequence, and the pixel electrodes of the pixel units P(k+1)1, . . . , and Pn1 are charged by the second data line D1 _b in sequence. The pixel units P11, P21, . . . , and Pk1 constitute the first pixel unit group, and the pixel units P(k+1)1, . . . , and Pn1 constitute the second pixel unit group.

### Embodiment 4

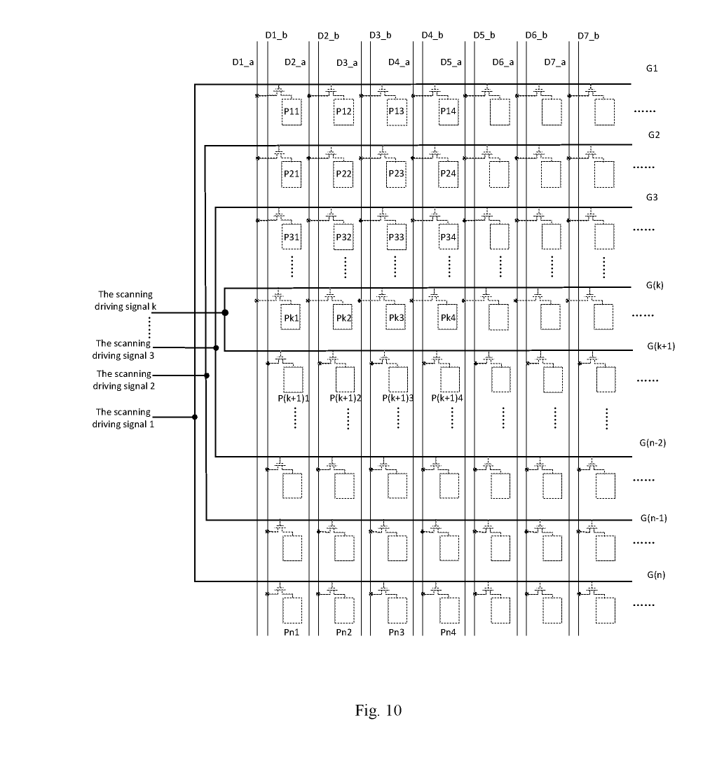

FIG. 10 schematically shows a structure of a liquid crystal display panel according to the present embodiment. Similar to embodiment 3, according to the present embodiment, n is preferably selected to be an even number, and k=n/2. G1, G2, . . . , and G(k) are the first scanning lines, and G(k+1), G(k+2), . . . , and G(n) are the second scanning lines. The pixel units P11, P21, . . . , and Pk1 constitute the first pixel unit group, and the pixel units P(k+1)1, . . . , and Pn1 constitute the second pixel unit group.

As shown in FIG. 10, the scanning line G1 and the scanning line G(n) are connected with the TFT switches of the first row of pixel units and the TFT switches of the n row of pixel units respectively, so that the TFT switches of the first row of pixel units and the TFT switches of the n row of pixel units can be turned on simultaneously according to the scanning driving signal 1 during the display, and the pixel electrodes of the pixel units in the first row and the n row can be charged by the data lines D1_a, D1_b, D2_a, D2_b, etc through the TFT switches according to the data driving signal.

Similarly, the TFT switches of the second row of pixel units and the TFT switches of the (n−1) row of pixel units can be turned on simultaneously by the scanning lines G2 and G(n−1) according to the scanning driving signal 2, and the pixel electrodes of the pixel units in the second row and the (n−1) row can be charged by the data lines through the TFT switches.

In this manner, the turned-on time of the TFT switches of the first row of pixel units, the n row of pixel units, the second row of pixel units, and the (n−1) row of pixel units all can be doubled. Therefore, the turned-on time of the TFT switches in each row of pixel units can be increased, and thus the charge time of the pixel electrodes can be prolonged.

Since the connection mode of the scanning lines of the liquid crystal display panel according to the present embodiment is different from that of embodiment 3, the method for driving the liquid crystal display device according to the present embodiment is different from that of embodiment 3. During one frame cycle, in the (k+1) row of pixel units to the n row of pixel units, the scanning of then row of pixel units is performed at first and the scanning of the (k+1) row of pixel units is performed at last according to the present embodiment, while the scanning of the (k+1) row of pixel units is performed at first and the scanning of the n row of pixel units is performed at last according to embodiment 3.

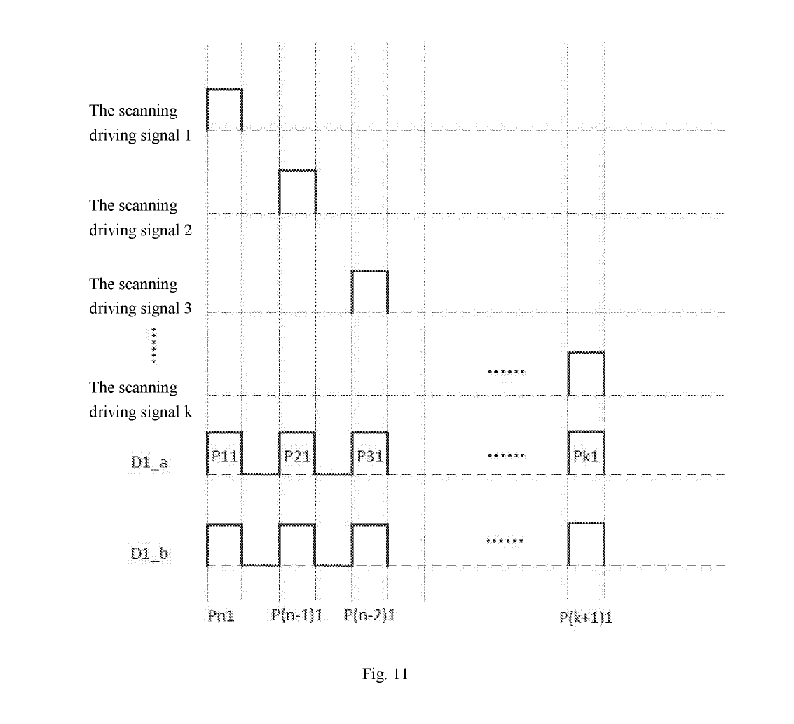

As shown in FIG. 11, taking the pixel units in the first column as an example, the pixel electrodes of the pixel units P11, P21, . . . , and Pk1 are charged by the first data line D1_a in sequence, and the pixel electrodes of the pixel units Pn1, P(n−1)1, . . . , and P(k+1)1 are charged by the second data line D1_b in sequence. The pixel units P11, P21, . . . , and Pk1 constitute the first pixel unit group, and the pixel units P(k+1)1, . . . , and Pn1 constitute the second pixel unit group.

The above embodiments are described only for better understanding, rather than restricting, the present disclosure. Any person skilled in the art can make amendments to the implementing forms or details without departing from the spirit and scope of the present disclosure. The protection scope of the present disclosure shall be determined by the scope as defined in the claims.

1. A liquid crystal display panel, comprising:
a plurality of data line pairs, each of data line pair comprising a first data line and a second data line that are arranged side by side;
a plurality of scanning lines, comprising a first scanning line and a second scanning line that are arranged alternately and perpendicular to the plurality of data line pairs; and
a pixel unit array, comprising a plurality of pixel units, each of which is arranged in a respective one of areas formed by the plurality of data line pairs and the plurality of scanning lines crossing over with one another respectively, each pixel unit comprising a pixel electrode and a TFT switch,
wherein the first scanning line and the second scanning line turn on TFT switches of two rows of pixel units simultaneously according to a scanning driving signal, and the first data line and the second data line charge the pixel electrodes of two rows of pixel units through the TFT switches according to a data driving signal.

2. The liquid crystal display panel according to claim 1, wherein each column of pixel units are arranged on a same side of a corresponding data line pair, and sources of the TFT switches of each column of pixel units are connected with the first data line and the second data line of said corresponding data line pair alternately.

3. The liquid crystal display panel according to claim 2, wherein the first scanning line and the second scanning line are arranged adjacent to each other and separated by one row of pixel units, and a first pixel unit and a second pixel unit of each column of pixel units are arranged alternately.

4. The liquid crystal display panel according to claim 2, wherein the first scanning line and the second scanning line are separated by k rows of pixel units, k first scanning lines are arranged adjacent to each other, and k second scanning lines are arranged adjacent to each other, k being equal to or larger than 2 and equal to or less than n/2, n being a number of rows of the pixel unit array, k and n being positive integers; and
wherein each column of pixel units comprises a first pixel unit group and a second pixel unit group that are arranged alternately, the first pixel unit group comprising k adjacent first pixel units, and the second pixel unit group comprising k adjacent second pixel units.

5. The liquid crystal display panel according to claim 2, wherein a gate of the TFT switch of the first pixel unit is connected with the first scanning line, and a source thereof is connected with the first data line; and
wherein a gate of the TFT switch of the second pixel unit is connected with the second scanning line, and a source thereof is connected with the second data line.

6. A liquid crystal display device, comprising:
a liquid crystal display panel, which comprises a plurality of data line pairs, each data line pair comprising a first data line and a second data line that are arranged side by side; a plurality of scanning lines, comprising a first scanning line and a second scanning line that are arranged alternately and perpendicular to the plurality of data line pairs; and a pixel unit array, comprising a plurality of pixel units, each of which is arranged in a respective one of areas formed by the plurality of data line pairs and the plurality of scanning lines crossing over with one another respectively, each pixel unit comprising a pixel electrode and a TFT switch;
a scanning driving unit, used for providing a scanning driving signal to the first scanning line and the second scanning line, so as to turn on TFT switches of two rows of pixel units simultaneously; and
a data driving unit, used for providing a data driving signal to the first data line and the second data line, so as to charge the pixel electrodes of two rows of pixel units through the TFT switches.

7. The liquid crystal display device according to claim 6, wherein the data driving unit further charges the pixel electrodes of each column of pixel units through the first data line and the second data line alternately.

8. The liquid crystal display device according to claim 6, wherein each column of pixel units are arranged on a same side of a corresponding data line pair, and sources of the TFT switches of each column of pixel units are connected with the first data line and the second data line of said corresponding data line pair alternately.

9. The liquid crystal display device according to claim 8, wherein the data driving unit further charges the pixel electrodes of each column of pixel units through the first data line and the second data line alternately.

10. The liquid crystal display device according to claim 8, wherein the first scanning line and the second scanning line are arranged adjacent to each other and separated by one row of pixel units, and a first pixel unit and a second pixel unit of each column of pixel units are arranged alternately.

11. The liquid crystal display device according to claim 10, wherein the data driving unit further charges the pixel electrodes of each column of pixel units through the first data line and the second data line alternately.

12. The liquid crystal display device according to claim 10, wherein the first scanning line and the second scanning line are separated by k rows of pixel units, k first scanning lines are arranged adjacent to each other, and k second scanning lines are arranged adjacent to each other, k being equal to or larger than 2 and equal to or less than n/2, n being a number of rows of the pixel unit array, k and n being positive integers; and
wherein each column of pixel units comprises a first pixel unit group and a second pixel unit group that are arranged alternately, the first pixel unit group comprising k adjacent first pixel units, and the second pixel unit group comprising k adjacent second pixel units.

13. The liquid crystal display device according to claim 12, wherein the data driving unit further charges the pixel electrodes of each column of pixel units through the first data line and the second data line alternately.

14. The liquid crystal display device according to claim 12, wherein a gate of the TFT switch of the first pixel unit is connected with the first scanning line, and a source thereof is connected with the first data line; and
wherein a gate of the TFT switch of the second pixel unit is connected with the second scanning line, and a source thereof is connected with the second data line.

15. The liquid crystal display device according to claim 14, wherein the data driving unit further charges the pixel electrodes of each column of pixel units through the first data line and the second data line alternately.

16. A method for driving a liquid crystal display device, comprising the following steps:
providing a scanning driving signal to a first scanning line and a second scanning line, and turning on TFT switches of two rows of pixel units simultaneously; and
providing a data driving signal to a first data line and a second data line, and charging pixel electrodes of two rows of pixel units through the TFT switches.

17. The method according to claim 16, further comprising charging the pixel electrodes of each column of pixel units through the first data line and the second data line alternately.

18. The method according to claim 17,
wherein under the condition that the first scanning line and the second scanning line are arranged adjacent to each other and separated by one row of pixel units, the method comprises charging pixel electrodes of a first pixel unit and a second pixel unit of each column of pixel units through the first data line and the second data line alternately; and
wherein under the condition that the first scanning line and the second scanning line are separated by k rows of pixel units, k first scanning lines are arranged adjacent to each other, and k second scanning lines are arranged adjacent to each other, the method comprises charging pixel electrodes of a first pixel unit group and a second pixel unit group of each column of pixel units through the first data line and the second data line alternately, the first pixel unit group comprising k adjacent first pixel units, the second pixel unit group comprising k adjacent second pixel units, k being equal to or larger than 2 and equal to or less than n/2, n being a number of rows of the pixel unit array, k and n being positive integers.
